(19) United States
(12) Patent Application Publication
(10) Pub. No.: US 2006/0085415 A1
(43) Pub. Date: Apr. 20, 2006

(54) Multiple conditions dynamic data sorting apparatus and method

(76) Inventor: Ming-Yu Jian, Kweishan (TW)

Correspondence Address: HOFFMAN WARNICK & D'ALESSANDRO, LLC, 75 STATE STREET, 14TH FL, ALBANY, NY, 12207, US

(21) Appl. No.: 11/236,978

(22) Filed: Sep. 28, 2005

(30) Foreign Application Priority Data
Sep. 29, 2004 (TW) 093129491

(51) Int. Cl. G06F 17/30

(52) U.S. Cl. 707/5

(57) ABSTRACT

The invention provides a data sorting apparatus, which sorts a plurality of contact data according to their events. The data sorting apparatus includes a memory module, a mapping module, a calculation module and a sorting module. The memory module is used to store the contact data and events, where each event corresponds to a predetermined weighting. The mapping module is used to map each contact data dynamically to a group of instantaneous data associated with the events. The calculation module generates a weighting for each of the contact data in accordance with the instantaneous data and the predetermined weighting corresponding to each of the events. The sorting module sorts the contact data in accordance with the weighting corresponding to each of the contact data and a first predetermined order.

### BACKGROUND OF THE INVENTION

1. Field of the Invention

This present invention relates generally to a data sorting apparatus, and more particularly, to a multi-condition dynamic data sorting apparatus.

2. Description of the Prior Art

Typical sorting methods for contact data in mobile phones can be categorized into two classes. One of the typical sorting methods sorts the contact data in mobile phones in alphabetic order. Users have to browse the data in the contact list sequentially until they have found a specific record. The other of the typical sorting methods is to sort the contact data in chronological order according to various events, such as the dialed calls, answered or unanswered calls. The later one helps users to find out the contact data related to the latest events. However, a single record of contact data might appear in different events repeatedly, resulting in redundant entries in the history of events. Besides, the chronological order by events gradually cannot meet users' demand because it does not take the difference and importance between individual records of the contact data into account.

U.S. Pat. No. 6,606,381 disclosed another sorting method that arranges the contact data dynamically according to the accumulated count of communications. The aforesaid method gives higher priority to those contact data with high communication frequency and lower priority to those contact data with low communication frequency. Such type of sorting method reflects users' long-term behavior of communication by dynamically sorting the data according to communication frequency. The shortcomings of this method are that it cannot provide an immediate response to the change of communication behavior in a short-term manner, and that it still does not put the difference and importance of various contact data into consideration. In other words, this method only considers the factors of time and communication frequency without taking advantage of other information.

Accordingly, a major objective of the invention is to provide a data sorting apparatus and method to resolve the problems mentioned above.

### SUMMARY OF THE INVENTION

An object of the invention is to provide a data sorting apparatus to help user obtain the most-suited data sorting by dynamically altering sorting conditions according to their needs. The invention provides a data sorting apparatus for sorting a plurality of contact data according to a plurality of events. The apparatus includes a memory module, a mapping module, a calculation module and a sorting module. The memory module is used to store the contact data and events, where each of the events corresponds to a predetermined weighting. The mapping module, connected to the memory module, is used to map each of the contact data dynamically to a group of instantaneous data associated with the events in accordance with a set of mapping conditions. The calculation module, connected to the memory module and the mapping module, is used to generate a weighting corresponding to each of the contact data in accordance with the instantaneous data mapped to each of the contact data and the predetermined weighting corresponding to each of the events. The sorting module, connected to the calculation module, is used to sort the contact data in accordance with the weighting corresponding to each of the contact data and a first predetermined order.

The invention also provides a data sorting method for sorting a plurality of contact data according to a plurality of events. Firstly, the method stores the contact data and events, where each of the events corresponds to a predetermined weighting. Then, the method maps each of the contact data dynamically to a group of instantaneous data associated with the events in accordance with a set of mapping conditions. Next, the method generates a weighting corresponding to each of the contact data in accordance with the instantaneous data mapped to each of the contact data and the predetermined weighting corresponding to each of the events. Finally, the contact data are sorted in accordance with the weighting corresponding to each of the contact data and a first predetermined order.

In an embodiment of the data sorting apparatus and method according to the invention, each of the contact data is assigned to different weightings corresponding to various events. The contact data are sorted according to the accumulated weighting assigned to each of the contact data. The specific record of contact data having highest weighting is the most important item in a user-defined measure. When the apparatus and method are applied to mobile phones, the contact data are sorted so that the records with high weightings appear at the first entries of the contact list. As a result, it simplifies the task for users to find important contact data. The advantage and spirit of the invention may be understood by the following recitations together with the appended drawings.

### BRIEF DESCRIPTION OF THE APPENDED DRAWINGS

FIG. 1 is a function block diagram of the data sorting apparatus according to the invention.

FIG. 2 shows an example of events and the corresponding predetermined weightings according to an embodiment of the invention.

FIG. 3 is a flowchart of the data sorting method according to the invention.

FIG. 4 is a flowchart of step S42 depicted in FIG. 3 according to the data sorting method of the invention.

### DETAILED DESCRIPTION OF THE INVENTION

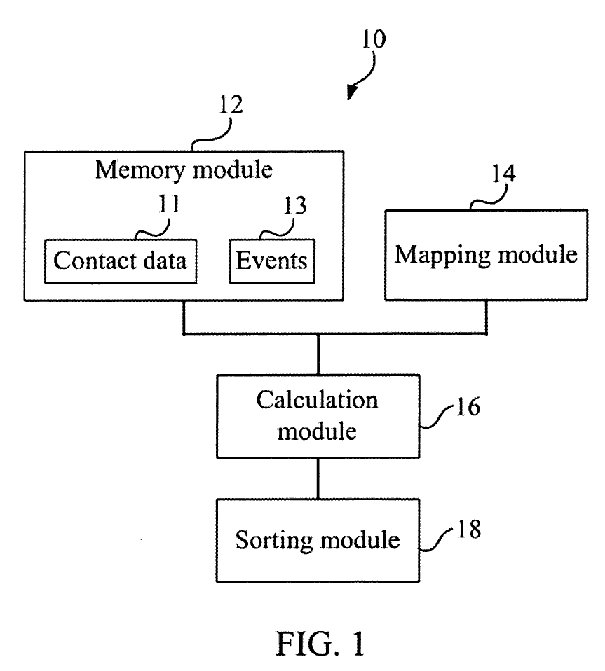

FIG. 1 is the function block diagram of the data sorting apparatus 10 according to the invention. The apparatus 10 sorts a plurality of contact data according to a plurality of events. The data sorting apparatus 10 includes a memory module 12, a mapping module 14, a calculation module 16 and a sorting module 18.

The memory module 12 is used to store the plurality of contact data 11 and the plurality of events 13, where each of the events 13 corresponds to a predetermined weighting. The mapping module 14 is connected to the memory module 12, and maps, according to a set of mapping conditions, each of the contact data 11 dynamically to a group of instantaneous data associated with the events 13. In an embodiment, the mapping conditions include a set of communication information. Moreover, the apparatus 10 further includes a mobile communication module (not shown in FIG. 1) for wirelessly receiving the communication information.

The calculation module 16 is connected to the memory module 12 and the mapping module 14, respectively. The calculation module 16 functions generating a weighting corresponding to each of the contact data 11 in accordance with the instantaneous data mapped to each of the contact data 11 and the predetermined weighting corresponding to each of the events 13. In an embodiment, the weighting corresponding to each of the contact data 11 is the sum of the predetermined weighting of each event 13 associated with the instantaneous data mapped to each of the contact data 11. Because each of the contact data 11 might be associated with multiple events 13, the apparatus 10 collects all events 13 associated with each of the contact data 11 into the instantaneous data, and then generates the weighting corresponding to each of the contact data 11 by summing up the predetermined weighting of each event 13 contained in the instantaneous data. In another embodiment, the weighting corresponding to each of the contact data 11 is the weighted sum of the predetermined weighting of each event 13 associated with the instantaneous data mapped to each of the contact data 11.

The sorting module 18 is connected to the calculation module 16, and functions sorting the contact data 11 in accordance with the weighting corresponding to each of the contact data 11 and a first predetermined order. In an embodiment, the first predetermined order is to sort the contact data 11 in ascending order in accordance with the weighting corresponding to each of the contact data 11. In another embodiment, the first predetermined order is to sort the contact data 11 in descending order in accordance with the weighting corresponding to each of the contact data 11. In addition, the data sorting apparatus 10 can further include a display module (not shown in FIG. 1), connected to the sorting module 18, to display the sorted contact data.

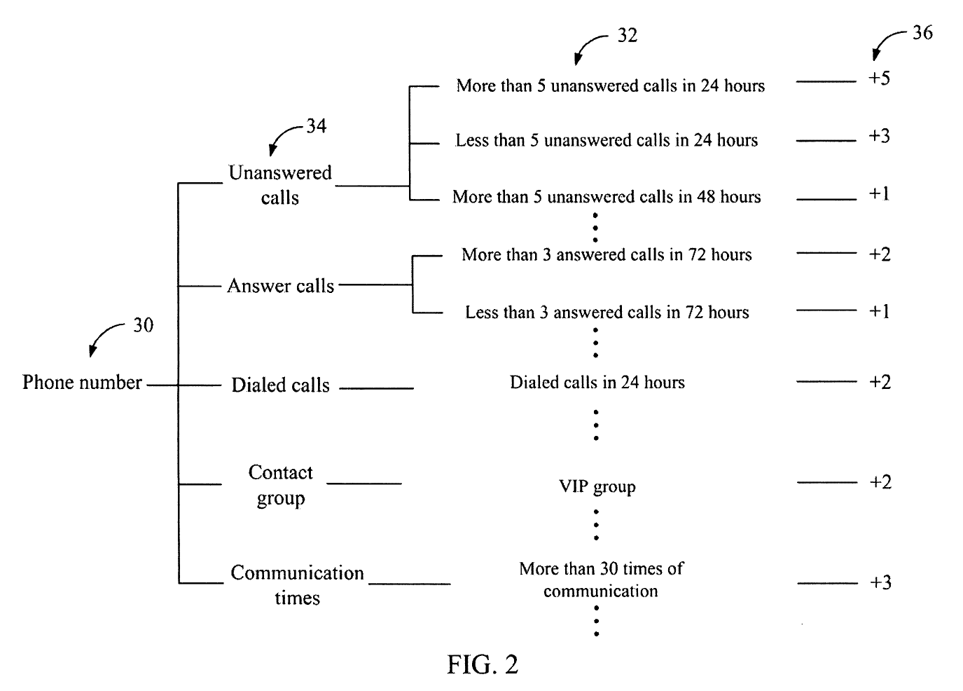

FIG. 2 shows an example of events and the corresponding predetermined weightings according to an embodiment of the invention. Applied to mobile phones, the apparatus 10 according to the invention is used to sort the contact data 11 stored in these devices. In this embodiment, the contact data 11 are a set of phone numbers 30 and the events 13 are various states 32 associated with a phone number 30, such as more than 5 unanswered calls in 24 hours, less than 5 unanswered calls in 24 hours, more than 5 unanswered calls in 48 hours and more than 3 answered calls in 72 hours and so on. Therefore, users define a predetermined weighting 36 that corresponds to each state 32. Typically, a mobile phone defines a group of classifiers 34 assignable to a phone number 30, such as answered calls, unanswered calls and dialed calls etc. The states 32 of a phone number can also be assigned to one of the classifiers 34. For example, the state of more than 5 unanswered calls in 24 hours can be assigned to the classifier of unanswered calls, whereas the state of more than 3 answered calls in 72 hours can be assigned to the classifier of answered calls. Users are allowed to determine the most-suited weightings 36 corresponding to the states 32, such as +5, +3, +1, +2 etc., to meet their needs. For example, if users are concerned about unanswered calls, they can give higher predetermined weightings to the states 32 assigned to the classifier 34 of unanswered calls so as to raise their priority in data sorting. It is possible that a phone number 30 is associated with multiple states 32, e.g. more than 5 unanswered calls in 24 hours and more than 3 answered calls in 72 hours. Therefore, it is necessary to collect all states 32 associated with a phone number 30 into a group of instantaneous data, and then to generate the weighting corresponding to each phone number 30 by summing up the predetermined weighting of each state 32 contained in the instantaneous data. The phone numbers (the contact data) are then sorted according to the user-defined weightings.

In an embodiment, the apparatus 10 according to the invention is capable of displaying the contact data 11 stored in the apparatus 10 in a way that meets users' preferences and needs. When the novel data sorting functionality is enabled, the apparatus 10 sorts the contact data 11 according to the predetermined weightings 36 and places the most significant data at the first entries of the contact list so that users can find these data more efficiently. After that, the weightings corresponding to the contact data update as various events occur and the apparatus rearranges the data according to the updated weightings. The apparatus of the invention eases the inconvenience of sequential search or string query for a special record of contact data through the whole contact list. By the apparatus of the invention, it will be easier for users to access important contact data.

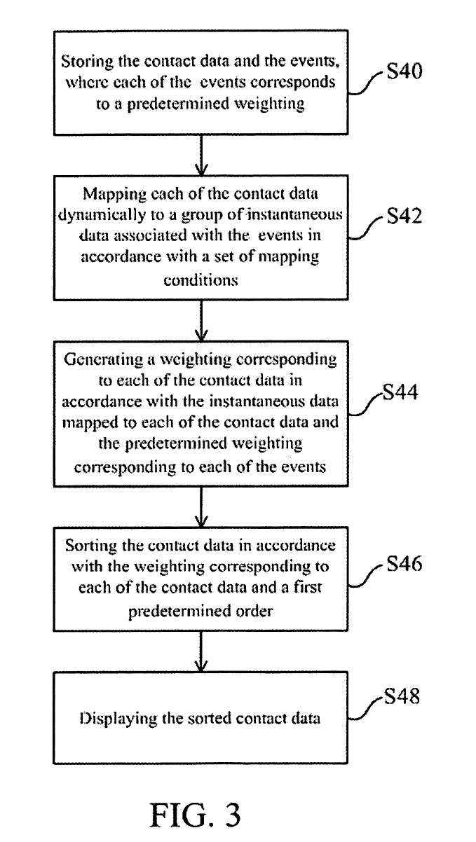

FIG. 3 is a flowchart of the data sorting method according to the invention. The method sorts a plurality of contact data according to a plurality of events. Initially, step S40 is performed to store the contact data and events, where each of the events corresponds to a predetermined weighting. Afterwards, step S42 is performed to map each of the contact data dynamically to a group of instantaneous data associated with the events in accordance with a set of mapping conditions. Step S44 is then performed. In step S44, a weighting corresponding to each of the contact data is generated in accordance with the instantaneous data mapped to each of the contact data and the predetermined weighting corresponding to each of the events. Next, step S46 is performed to sort the contact data in accordance with the weighting corresponding to each of the contact data and a first predetermined order. Finally, step S48 is performed to display the sorted contact data.

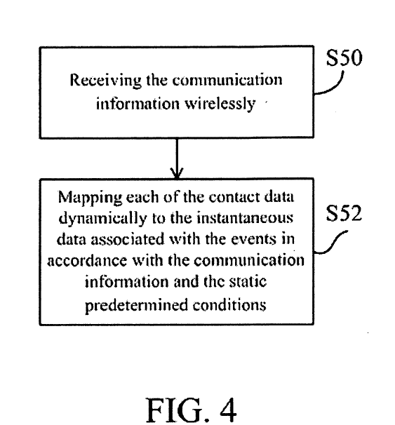

FIG. 4 is a flowchart of step S42 depicted in FIG. 3 according to the data sorting method of the invention. In an embodiment of step S42, the mapping conditions include a set of communication information and static predetermined conditions. As shown in FIG. 4, step S50 is performed to receive the communication information wirelessly. Subsequently, step S52 is performed to map each of the contact data dynamically to the instantaneous data associated with the events in accordance with the communication information and the static predetermined conditions.

In an embodiment of step S44, the weighting corresponding to each of the contact data is the sum of the predetermined weighting of each event associated with the instantaneous data mapped to each of the contact data. In another embodiment, the weighting corresponding to each of the contact data is the weighted sum of the predetermined weighting of each event associated with the instantaneous data mapped to each of the contact data.

In an embodiment of step S46, the first predetermined order is to sort the contact data in ascending order in accordance with the weighting corresponding to each of the contact data. In another embodiment, the first predetermined order is to sort the plurality of contact data in descending order in accordance with the weighting corresponding to each of the contact data. In a preferred embodiment of the data sorting apparatus and method according to the invention, the contact data are sorted in accordance with the occurrence of events during a period and the corresponding weightings that are defined by users. In addition, the invention can utilize other existing functions of mobile devices, such as contact group, schedule and messages, to further enhance user control over data sorting by defining weightings also on these functions. To summarize, this present invention provides a multi-condition dynamic data sorting apparatus and method for users to find significant contact data conveniently. For this purpose, users define various weighting of contact data according to their significance before sorting.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data sorting apparatus for sorting a plurality of contact data according to a plurality of events, said apparatus comprising:
a memory module for storing the plurality of contact data and the plurality of events, wherein each of the plurality of events corresponds to a predetermined weighting;
a mapping module, connected to the memory module, for mapping, according to a set of mapping conditions, each of the plurality of contact data dynamically to a group of instantaneous data associated with the plurality of events;
a calculation module, connected to the memory module and the mapping module respectively, for generating a weighting corresponding to each of the plurality of contact data in accordance with the instantaneous data mapped to each of the contact data and the predetermined weighting corresponding to each of the plurality of events; and
a sorting module, connected to the calculation module, for sorting the plurality of contact data in accordance with the weighting corresponding to each of the plurality of contact data and a first predetermined order.

2. The data sorting apparatus of claim 1, wherein the weighting corresponding to each of the contact data is the sum of the predetermined weighting of each event associated with the instantaneous data mapped to each of the contact data.

3. The data sorting apparatus of claim 1, wherein the weighting corresponding to each of the contact data is the weighted sum of the predetermined weighting of each event associated with the instantaneous data mapped to each of the contact data.

4. The data sorting apparatus of claim 1, wherein the first predetermined order is to sort the plurality of contact data in ascending order in accordance with the weighting corresponding to each of the contact data.

5. The data sorting apparatus of claim 1, wherein the first predetermined order is to sort the plurality of contact data in descending order in accordance with the weighting corresponding to each of the contact data.

6. The data sorting apparatus of claim 1, wherein the mapping conditions comprise a set of communication information, said apparatus further comprises a mobile communication module for receiving the communication information wirelessly.

7. The data sorting apparatus of claim 6, further comprising a display module, connected to the sorting module, for displaying the sorted contact data.

8. A data sorting method for sorting a plurality of contact data in accordance with a plurality of events, said method comprising the steps of:
(a) storing the plurality of contact data and the plurality of events, wherein each of the plurality of events corresponds to a predetermined weighting;
(b) according to a set of mapping conditions, mapping each of the plurality of contact data dynamically to a group of instantaneous data associated with the plurality of events;
(c) generating a weighting corresponding to each of the plurality of contact data in accordance with the instantaneous data mapped to each of the contact data and the predetermined weighting corresponding to each of the plurality of events; and
(d) sorting the plurality of contact data in accordance with the weighting corresponding to each of the plurality of contact data and a first predetermined order.

9. The data sorting method of claim 8, wherein the weighting corresponding to each of the contact data is the sum of the predetermined weighting of each event associated with the instantaneous data mapped to each of the contact data.

10. The data sorting method of claim 8, wherein the weighting corresponding to each of the contact data is the weighted sum of the predetermined weighting of each event associated with the instantaneous data mapped to each of the contact data.

11. The data sorting method of claim 8, wherein the first predetermined order is to sort the plurality of contact data in ascending order in accordance with the weighting corresponding to each of the contact data.

12. The data sorting method of claim 8, wherein the first predetermined order is to sort the plurality of contact data in descending order in accordance with the weighting corresponding to each of the contact data.

13. The data sorting method of claim 8, wherein the mapping conditions comprise a set of communication information and a set of static predetermined conditions, step (b) further comprises the steps of:
(b1) receiving the communication information wirelessly; and
(b2) mapping each of the plurality of contact data dynamically to the instantaneous data associated with the plurality of events in accordance with the communication information and the static predetermined conditions.

14. The data sorting method of claim 8, further comprising the step of:
(e) displaying the sorted contact data.
